(19) United States
(12) Patent Application Publication
(10) Pub. No.: US 2005/0065932 A1
(43) Pub. Date: Mar. 24, 2005

(54) System to provide an individual data processing environment

(76) Inventor: Carlos Cesar Moretzsohn Rocha, Sao Paulo (BR)

Correspondence Address: BIRCH STEWART KOLASCH & BIRCH, PO BOX 747, FALLS CHURCH, VA, 22040-0747, US

(21) Appl. No.: 10/496,881

(22) PCT Filed: Nov. 26, 2002
(86) PCT No.: PCT/BR02/00162

(30) Foreign Application Priority Data
Nov. 26, 2001 (BR) P10105727-8

(51) Int. Cl. G06F 7/00

(52) U.S. Cl. 707/9

(57) ABSTRACT

There is disclosed a system intended to provide each user with his or her individual data processing environment (1), with his or her identification (2) and his or her personal content (3), stored in a portable individual device (8), which interacts with a workstation (9), in order that the user may use sections of any application program (6) running in application servers (10), providing for each section of program (6) the respective processing capacity (7).

The present patent application refers to a novel information technology system, basically comprised by a local area network interconnecting several workstations (9) with application software (6) running in application servers (10), either local or remote, and with digital computing service networks, including the Internet, by means of a local communications server (12) and a router. Each workstation (9) acts as the user interface with the system, is comprised by a compact cabinet including a logic board that controls a keyboard, a mouse, a video monitor, a network interface and an external device interface (11) (“drive”), for an individual portable device (8) of any type, intended for storage the user profile, the identification (2) and the content information (3) of each person, thereby warranting the privacy of the user. This individual device (8) is a FlashCard® type memory card, a CD-RW, or any other device allowing data readout and re-recording or the recording of new sets of information, every time that a person uses the system. In the present implementation, there are used two individual portable devices (8): a FlashCard®, a re-recordable non-volatile flash-type memory card, with a unique serial number, intended for storage of the user profile and the content most frequently used, and a CD-RW for successive readout and writing of information, with a unique serial number, to equally store the individual user profile and the content least frequently used and with greater volume. These individual devices (8) may be used separately or jointly. The application servers (10) are computers dedicated to processing application software (6), used by the users, by means of the workstations (9). The communications server (12) is a specific application computer, intended to allow shared access to the external digital networks from the workstations (9). The system also includes one or more workstations (9), connected to the respective peripherals, for provision of printing services, services of digital scanning and reading of documents (Scanners), and of readout and recording of CD-RW, a type of CD-ROM media that allows readout and recording of data.

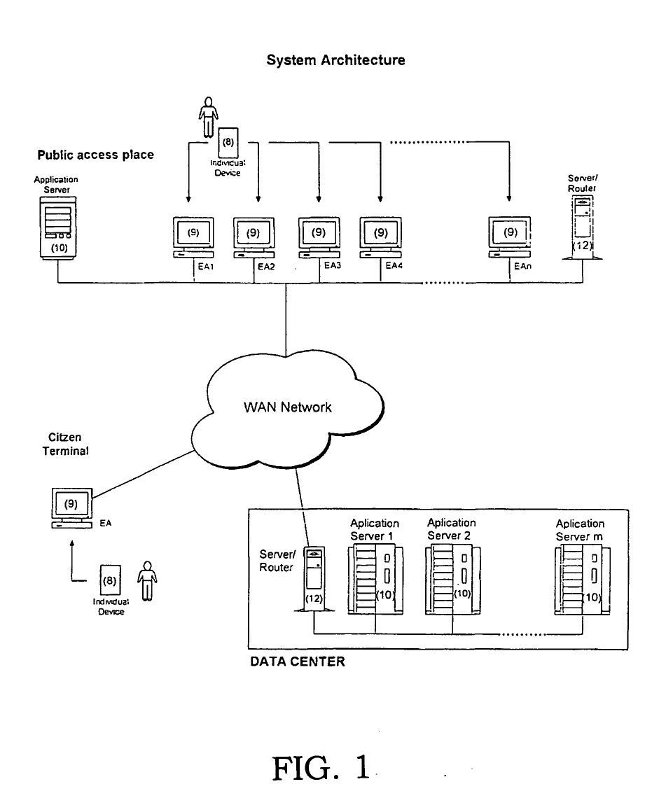

In FIG. 1 there is depicted a schematic representing the architecture of a data processing system.

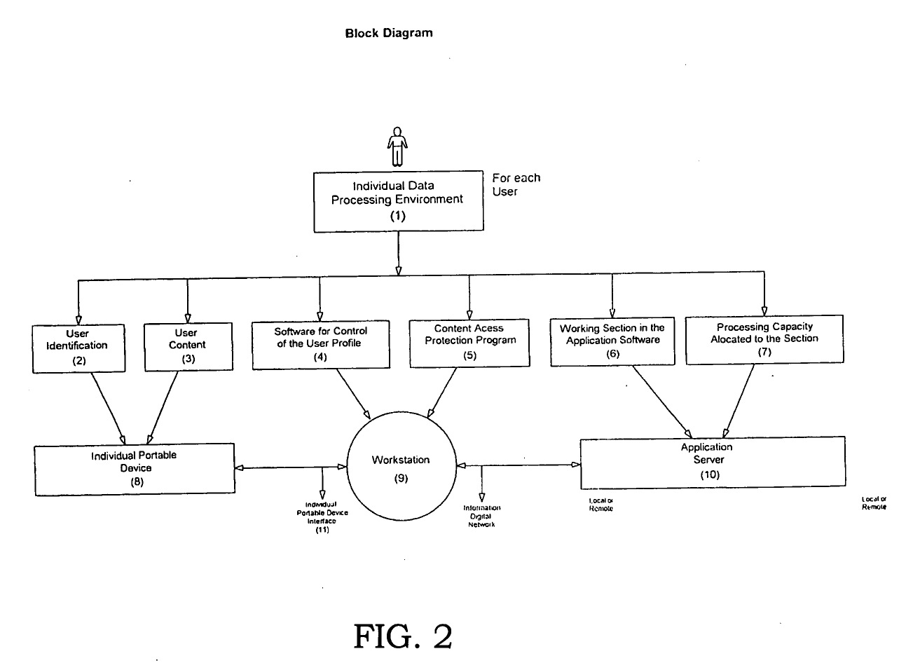

In FIG. 2 there is depicted the system according to the present invention in the form of a block diagram.

In order to use the system, a person gets hold of a workstation (9) and inserts therein his or her individual device (8), for example the FlashCard®. At this time, the user profile control program (4) requests the user to enter his or her name and password, which will be compared with the user profile already stored in his or her individual device (8). The authenticity of the data recorded in the individual device (8) is checked, with validation of the recorded digital signature, in the individual device (8), performed by the content access protection program (5) in the workstation (9). From this point onwards, the use experience is similar to that obtained using a last-generation personal microcomputer, that is, the workstation (9), integrated with the system, functions like a common PC-type microcomputer and allows access to the Internet and to all the usual applications, including an office-type application suite, which handles several types of documents. Total privacy is ensured by the system's operating method, whereby the application programs (6) are processed, in the application servers (10), but all the data and information that characterize an individual and personal environment (1), and one which is protected for each user, are stored only in the individual device (8). Upon ending a session of use of the system, no information relative to the users is kept stored in the system.

Therefore, although the network topology may appear usual and mostly all the system elements are available in the market, some significant innovations render the method both novel and revolutionary. The main innovation of the system resides in the method of use that is inherent to the system, which by means of the computer software for control of the user profile (4) and for protection of access to the content (5), implements the segregation of all the infrastructure required for use and operation of the application software (6), from everything that might characterize the individual profile of each user, that is, his or her user profile (2), and the content (3) of his or her private data. In the system, the individual device (8) that allows each user to have “his/her individual working environment (1)” ceases to be an equipment, a personal microcomputer, or a space in the memory and in the hard drive of the server, and is reduced to a mere individual portable device (8), a FlashCard®, or a CD-RW, or both, for example. The other important innovation is the workstation (9) Samurai 2000 IA, developed to integrate the system, that has just been certified in October of 2001, by the Office of the Secretary for Computing and Automation Policy of the Ministry for Science and Technology (Ministério da Ciência e Tecnologia—MCT), as a product developed in Brazil using domestic technology, containing a significant degree of technological innovation, as stated in Administrative Ruling (“Portaria”) MCT No. 214/94.

The system's innovations are aimed at eliminating the shortcomings that characterize the usual systems, and to supersede the paradigms that currently determine the digital exclusion (the “digital divide”) of citizens having low personal or family income. The system is a Brazilian solution for a challenge existing in our Country's reality, and was therefore developed to provide to any person his or her individual working environment (1), in the form of a complete service of extremely low cost, accessible to any citizen, and anywhere, irrespective of his or her level of family income and his or her capacity to purchase and use a personal microcomputer, or opting otherwise. The system will be installed in several public workplaces about the entire Country, to make available the individual working environment (1) in the form of a shared working service, warranting privacy to the citizen, for persons of any age, profession, formal educational level, or acquisitive power. It is a Brazilian solution to render feasible the digital inclusion in our Country.

The cost of a traditional popular computer, with means to access the Internet, is formed by the price of an equipment with reduced functionality, in order that the cost thereof may be the lowest possible, added to the cost of access to the Internet and to the cost of the respective telecommunications service, either by means of a dial-up connection or a wideband connection. On the other hand, the cost of the individual working environment (1) corresponds to only 5% (five percent) of the value of a low-cost traditional computer, since such cost is merely formed by the cost of the individual device (8), added to the cost of the shared working services of the system, including the access to the Internet and other services provided by digital information networks. By means of a standard-type credit line, for payment in up to 36 monthly installments, the individual working environment (1) will cost less than R$9,00 (nine Brazilian reais, equivalent in November of 2002 to about US$2.57) per month.

To this day, the standard networked services store the profile of each user, with information regarding his or her identity, name, password, and the information relative to use and preferences of each person, in the system servers, either local or remote. In the same manner, the current systems store the working environment and all the content used by each user, in the system servers. These two characteristics of the systems commonly used to this date, have the consequence that:
“the possibility of use, for each person, is limited to the system where such person is registered and has a defined permission for use;
“the privacy of the user may be jeopardized by the system administrators, who have total access to the information stored in the servers;
“the mobility of the user is limited to the points of presence wherein may exist workstations for the specific system wherein his or her user profile is recorded, reducing the work possibilities or rendering the systems extremely complex and their cost prohibitive.

All these limitations were eliminated with the system and the individual devices thereof (8): the FlashCard® and the CD-RW, both having recorded therein the identification of the user (2) and the personal content of each person (3), exhibiting as differentiated characteristics: the unique serial number, the content identified by a different digital signature to authenticate each user session, the individual profile of each user (2) authenticated by a name, a password and a digital signature, for each user, and in the case of the FlashCard®, the content access protection system, which prevents the readout and/or the recording of the data in the FlashCard® without the authorization of the card's proprietor.

The memory card designated as FlashCard® is a compact, lightweight and ergonomic device, and highly reliable (more than a million hours of MTBF) which, in its package fits into anyone's shirt pocket or wallet, having a weight of less than 50 g and dimensions smaller than a matchbox, allowing the FlashCard® to provide to every user a total mobility for use, allowing the same to be carried by any person to any place and at any time, without the possession thereof being noticeable to other persons, due to its tiny size, therefore adding security to its use.

1. (Cancelled)

2. A system for providing a user with an individual data processing environment, characterized by comprising:
an individual portable device, wherein the user's profile, identification files, and user's personal content are stored in said individual portable device;
a plurality of workstations connected by a local area network to a communications server, each workstation comprising an individual portable device interface for connecting the individual portable device thereto, wherein each workstation runs local software programs that, among other functions, control the access to the individual portable device;
a software running in said workstations for controlling the access to the user's profile and authentication stored in the individual portable device;
a software running in said workstations for controlling and protecting the access to the content of the individual portable device;
a local communications server, which enables shared access to the external digital networks from the workstations;
a digital information network; and
a plurality of application servers, connected anywhere on said network, dedicated for processing application software programs that are used by the users at the workstations.

3. A system of claim 2 characterized in that the individual portable device is a recordable compact disc (CD-R).

4. A system of claim 2 characterized in that the individual portable device is a re-writable compact disc (CD-RW).

5. A system of claim 2 characterized in that the individual portable device is a flash-type non-volatile re-writable memory card.

6. A system according to anyone of claims 2 to 5 characterized in that the individual portable device has a unique serial number.

7. A system according to claim 2 characterized in that the user's profile and identification files comprise user's identification, digital certificate, password, other authentication information, list and level of service information of application programs that the user can access, application servers location, application programs personal configuration files, and other system data.

8. A system according to claim 2 characterized in that the user's personal content comprise a personal wallpaper, and all personal files and other user content, such as images, photos and documents.

9. A system according to claim 2 characterized in that the digital information network comprises either the Internet, an intranet, or both.

10. A system according to claim 2 characterized in that the workstation comprises a compact cabinet including a logic board controlling a keyboard, a mouse, a video monitor and a network interface, without a local hard disk drive.

11. A system according to claim 2 characterized in that the workstation comprise peripherals.

12. A system according to claim 11 characterized in that the peripherals are printers.

13. A system according to claim 11 characterized in that the peripherals are scanners.

14. A system according to claim 2 characterized in that the individual portable device is a compact, light weight and ergonomic device being capable of fitting inside the shirt pocket or the wallet of the user.

15. A system according to claim 2 characterized in that the contents of the individual portable device are identified by a different digital signature to authenticate each user session.

16. A system according to claim 2 characterized in that the application server is local to the workstations.

17. A system according to claim 2 characterized in that the application server is remote to the workstations.
